(19) United States
(12) Patent Application Publication
(10) Pub. No.: US 2026/0250790 A1
(43) Pub. Date: Aug. 27, 2026

(54) METHOD AND SYSTEM FOR THE PRODUCTION OF DIFFERENT PRODUCTS UNDER DIFFERENT REDUCTION CONDITIONS IN DIFFERENT PORTIONS OF A SHAFT FURNACE

(71) Applicant: Midrex Technologies, Inc., Charlotte, NC (US)

(72) Inventor: Junichi Shiino, Charlotte, NC (US)

(21) Appl. No.: 19/456,082

(22) Filed: Jan. 22, 2026

Related U.S. Application Data
(60) Provisional application No. 63/762,707, filed on Feb. 25, 2025.

(51) Int. Cl. C21B 11/02; F27B 1/10; F27D 7/02; F27D 9/00

(52) U.S. Cl. CPC C21B 11/02; F27B 1/10; F27D 7/02; F27D 9/00; F27D 2009/0075; F27M 2003/13

(57) ABSTRACT

A shaft furnace for the direct reduction of iron includes a central flowpath defined by an innermost portion and a peripheral flowpath defined by another portion circumscribing the central flowpath, each extending from a top feed system to a transition zone or cooling zone below the reduction zone at a bottom of the shaft furnace. The central flowpath receives a distinct first flow of iron oxide and discharges a distinct first flow of reduced iron to the transition zone or cooling zone. The peripheral flowpath receives a distinct second flow of iron oxide and discharges a distinct second flow of reduced iron to the transition zone or cooling zone. A central reducing gas inlet and a peripheral reducing gas inlet of the shaft furnace are configured to, respectively, receive and counterflow a distinct first reducing gas within the central flowpath and a distinct second reducing gas within the peripheral flowpath.

### CROSS-REFERENCE TO RELATED APPLICATION

The present disclosure claims the benefit of priority of U.S. Provisional Patent Application No. 63/762,707, filed on Feb. 25, 2025, and entitled “METHOD AND SYSTEM FOR THE PRODUCTION OF DIFFERENT PRODUCTS UNDER DIFFERENT REDUCTION CONDITIONS IN DIFFERENT PORTIONS OF A SHAFT FURNACE,” the contents of which are incorporated in full by reference herein.

### TECHNICAL FIELD

The present disclosure relates generally to direct reduced iron (DRI) production and steelmaking fields. More specifically, the present disclosure relates to a direct reduction (DR) system and method for the production of different products under different reduction conditions in different portions of a shaft furnace (SF).

### BACKGROUND

When two or more different raw materials are reduced in a SF, the raw materials are typically mixed and fed into the SF together through the same charging device to ensure operational stability. For example, DRI is typically produced under a single reducing gas condition suited to the mixture of raw materials. In such cases, one constituent of the mixture can be a limiting factor. For example, when using a raw material that tends to be significantly disintegrated when reduced rapidly, the only solution is to either slow down the reduction rate of the mixture, lowering overall productivity, or limiting the use of the constituent that tends to be significantly disintegrated when reduced rapidly. The result is lower plant productivity, efficiency, and flexibility.

As such, a need exists in the art for a DRI system, SF, and associated process that overcome the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide a DRI system, SF, and associated process that overcome the limitations of the known art. Embodiments of the present disclosure improve upon prior systems and methods to produce DRI in a SF by utilizing distinct zones within the SF for reducing iron oxide with different characteristics or quality and potentially utilizing different reducing gases within such zones of the SF.

Generally, embodiments of the present DRI system, SF, and associated process enable the production of DRI or the like from different raw materials (or raw material mixtures) simultaneously in the center and outer periphery of a SF. In various embodiments, the SF may be equipped with a single or multiple raw material (or raw material mixture) feed devices, which can supply separate raw materials (or raw material mixtures) to the center and the outer periphery, respectively, at the top portion of the SF. Typically, the raw material or mixtures processed in these separate center and outer periphery zones will have different characteristics or quality (e.g., reducibility). Thus, embodiments of the SF of the present disclosure generally include two or more locations for injecting reducing gas and/or carburizing gas at the lower part of the reduction zone of the SF.

By feeding different raw materials (or raw material mixtures) with different chemical and/or physical properties separately into the center and outer periphery of the SF, without mixing, and injecting different reducing gas and/or carburizing gas with different conditions into the lower part of shaft furnace, different products can be generated simultaneously in different portions of the SF. In other embodiments, the same, substantially the same, or similar products can be generated simultaneously in the different portions of the SF despite the different raw materials (or raw material mixtures). Depending on the characteristics of the raw materials used in the center and outer periphery of the SF, conditions of the reducing gas and/or carburizing gas injected into such zones or portions of the SF can be changed independently to achieve optimal operation. It should be appreciated that, in at least some embodiments, different reducing gases and/or carburizing gases with different conditions include gases with the same composition, temperature, and pressure, but provided in different quantities and/or provided or injected at different rates. In at least some embodiments and/or use cases, raw material that is less prone to clustering may be introduced into the peripheral flowpath in order to reduce clustering, even if the same reducing gas temperature is utilized between the central and peripheral flowpaths.

To achieve the foregoing and other objects and advantages, in one aspect, the present subject matter is directed to a shaft furnace for the direct reduction of iron including a central flowpath and a peripheral flowpath. The central flowpath is defined by an innermost portion of the shaft furnace extending from a feed system at a top of the shaft furnace to at least one of a cooling zone or a transition zone located below a reduction zone of the shaft furnace. The central flowpath is configured to receive a distinct first flow of iron oxide and discharge a distinct first flow of reduced iron to the cooling zone and/or transition zone. The peripheral flowpath is defined by another portion of the shaft furnace circumscribing the central flowpath and extending from the feed system at the top of the shaft furnace to at least one of the cooling zone or the transition zone located below the reduction zone of the shaft furnace. The peripheral flowpath is configured to receive a distinct second flow of iron oxide and discharge a distinct second flow of reduced iron to the cooling zone and/or transition zone. The shaft furnace further includes a central reducing gas inlet configured to receive a distinct first reducing gas and counterflow the distinct first reducing gas within the central flowpath. The shaft furnace also includes a peripheral reducing gas inlet configured to receive a distinct second reducing gas and counterflow the distinct second reducing gas within the peripheral flowpath.

In at least one embodiments, the shaft furnace may further include the feed system at the top of the shaft furnace and configured to receive the distinct first flow of iron oxide and discharge the distinct first flow of iron oxide to the central flowpath of the shaft furnace. Additionally or alternatively, the feed system may be configured to receive the distinct second flow of iron oxide and discharge the distinct second flow of iron oxide to the peripheral flowpath of the shaft furnace. In some such embodiments or different embodiments, the central flowpath may be configured to reduce the distinct first flow of iron oxide only utilizing the counterflow of the distinct first reducing gas. Additionally or alternatively, the peripheral flowpath may be configured to reduce the distinct second flow of iron oxide only utilizing the counterflow of the distinct second reducing gas. In further or different embodiments, the shaft furnace may include one or more separating structure housed within the shaft furnace and at least partially defining and separating the central flowpath and the peripheral flowpath. Additionally or alternatively, the central reducing gas inlet may be located below the peripheral reducing gas inlet.

In at least one embodiment, the shaft furnace may further include a central carburizing gas inlet configured to receive a distinct first carburizing gas and inject the distinct first carburizing gas into the central flowpath. Additionally or alternatively, the shaft furnace may include a peripheral carburizing gas inlet configured to receive a distinct second carburizing gas and inject the distinct second carburizing gas into the peripheral flowpath.

In further or alternative embodiments, the shaft furnace may include the cooling zone positioned below the central flowpath and the peripheral flowpath. The cooling zone may be configured to receive and cool each of the distinct first flow of reduced iron and the distinct second flow of reduced iron and discharge an intermixed, cooled reduced iron from the bottom of the shaft furnace. Additionally or alternatively, the shaft furnace may include the transition zone positioned below the central flowpath and the peripheral flowpath. The transition zone may be configured to receive each of the distinct first flow of reduced iron and the distinct second flow of reduced iron and discharge an intermixed reduced iron from the bottom of the shaft furnace.

In an additional or alternative aspect, the present subject matter is directed to a method for the direct reduction of iron. The method includes receiving a distinct first flow of iron oxide at a top of a shaft furnace and directing the distinct first flow of iron oxide to a central flowpath defined by an innermost portion of the shaft furnace and extending from a feed system at a top of the shaft furnace to at least one of a transition zone or a cooling zone located below a reduction zone of the shaft furnace. The method further includes receiving a distinct second flow of iron oxide at a top of a shaft furnace and directing the distinct second flow of iron oxide to a peripheral flowpath defined by another portion of the shaft furnace circumscribing the central flowpath and extending from the feed system at the top of the shaft furnace to at least one of the transition zone or the cooling zone located below the reduction zone of the shaft furnace. The method also includes counterflowing a distinct first reducing gas within the central flowpath such that the distinct first flow of iron oxide is reduced within the central flowpath and forms a distinct first flow of reduced iron. The method further includes counterflowing a distinct second reducing gas within the peripheral flowpath such that the distinct second flow of iron oxide is reduced within the peripheral flowpath and forms a distinct second flow of reduced iron.

In at least one embodiment, the iron oxide of the distinct second flow of iron oxide directed to the peripheral flowpath may be less prone to clustering that the iron oxide of the distinct first flow of iron oxide directed to the central flowpath.

In at least one embodiment, receiving the distinct first flow of iron oxide at the top of the shaft furnace, directing the distinct first flow of iron oxide to the central flowpath, receiving the distinct second flow of iron oxide at the top of the shaft furnace, and directing the distinct second flow of iron oxide to the peripheral flowpath may include one or more of: receiving the distinct first flow of iron oxide and the distinct second flow of iron oxide at a feed system at the top of the shaft furnace; discharging, from the feed system, the distinct first flow of iron oxide to the central flowpath of the shaft furnace; or discharging, from the feed system, the distinct second flow of iron oxide to the peripheral flowpath of the shaft furnace. Additionally or alternatively, the method may include premixing a material within one of the distinct first flow of iron oxide or the distinct second flow of iron oxide prior directing to the respective central flowpath or the peripheral flow path in order to reduce or eliminate a difference in ventilation resistances of the distinct first flow of iron oxide and the distinct second flow of iron oxide.

In some such embodiments or different embodiments, the method may include injecting into the central flowpath a distinct first carburizing gas. In some embodiments of the method, the shaft furnace may include one or more separating structures housed within the shaft furnace and at least partially defining and separating the central flowpath and the peripheral flowpath. Additionally or alternatively, the method may include injecting within the central flowpath the distinct first reducing gas utilizing a central reducing gas inlet of the shaft furnace. Furthermore or in different embodiments, the method may include injecting within the peripheral flowpath the distinct second reducing gas utilizing a peripheral reducing gas inlet of the shaft furnace. In some such embodiments, the central reducing gas inlet may be located below the peripheral reducing gas inlet. Additionally or alternatively, the distinct second reducing gas may be injected within the peripheral flowpath at a higher temperature relative to the distinct first reducing gas injected within the central flowpath. Additionally or alternatively, the method may include controlling an amount of each of the distinct first reducing gas counterflowed within the central flowpath and the distinct second reducing gas counterflowed within the peripheral flowpath based, at least in part, on a ratio of the received distinct first flow of iron oxide and the received distinct second flow of iron oxide.

In some embodiments, the method may include receiving, at the cooling zone, each of the distinct first flow of reduced iron and the distinct second flow of reduced iron. Furthermore or alternatively, the method may include cooling and intermixing the distinct first flow of reduced iron and the distinct second flow of reduced iron within the cooling zone to form a cooled, intermixed reduced iron. Additionally or alternatively, the method may include discharging, from the cooling zone and at the bottom of the shaft furnace, the intermixed, cooled reduced iron. In an additional or alternative embodiment, the method may include receiving, at the transition zone, each of the distinct first flow of reduced iron and the distinct second flow of reduced iron. Additionally or alternatively, the method may include intermixing the distinct first flow of reduced iron and the distinct second flow of reduced iron within the transition zone to form an intermixed reduced iron. In some such embodiments or different embodiments, the method may include discharging, from the transition zone and at a bottom of the shaft furnace, the intermixed reduced iron.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the accompanying drawings, in which:

FIG. 1 illustrates a schematic diagram of an exemplary embodiment of a SF including separate central and peripheral zones or portions for the separate reduction of different flows of iron oxide material or mixtures, in accordance with aspects of the present subject matter;

FIG. 2 illustrates a schematic, cross-sectional view of an exemplary embodiment of an upper portion of a SF including a feed system having multiple feed devices, in accordance with aspects of the present subject matter;

FIG. 3 illustrates a heat map of an exemplary embodiment of a SF including multiple reducing gas injection points, in accordance with aspects of the present subject matter;

FIG. 4A illustrates exemplary embodiments of method elements, one or more of which may be implemented in a method for the direct reduction of iron utilizing central and peripheral zones or portions of the SF, in accordance with aspects of the present subject matter;

FIG. 4B illustrates exemplary embodiments of method elements, one or more of which may be implemented in a method for the direct reduction of iron utilizing central and peripheral zones or portions of the SF, in accordance with aspects of the present subject matter;

FIG. 4C illustrates exemplary embodiments of method elements, one or more of which may be implemented in a method for the direct reduction of iron utilizing central and peripheral zones or portions of the SF, in accordance with aspects of the present subject matter;

FIG. 4D illustrates exemplary embodiments of method elements, one or more of which may be implemented in a method for the direct reduction of iron utilizing central and peripheral zones or portions of the SF, in accordance with aspects of the present subject matter; and

FIG. 4E illustrates exemplary embodiments of method elements, one or more of which may be implemented in a method for the direct reduction of iron utilizing central and peripheral zones or portions of the SF, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first,” “second,” “third,” and the like may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, in various exemplary embodiments, the DRI system, SF, and associated process enable the production of DRI or the like from different raw materials (or raw material mixtures) simultaneously in the center and outer periphery of a SF. In various embodiments, the SF may be equipped with a single or multiple raw material (or raw material mixture) feed devices, which can supply separate raw materials (or raw material mixtures) to the center and the outer periphery, respectively, at the top portion of the SF. Typically, the raw material or mixtures processed in these separate center and outer periphery zones will have different characteristics or quality (e.g., reducibility). Thus, embodiments of the SF of the present disclosure generally include two or more locations for injecting reducing gas and/or carburizing gas at the lower part of the reduction zone of the SF.

By feeding different raw materials (or raw material mixtures) with different chemical and/or physical properties separately into the center and outer periphery of the SF, without mixing, and injecting different reducing gas and/or carburizing gas with different conditions into the lower part of shaft furnace, different products can be generated simultaneously in different portions of the SF. In other embodiments, the same, substantially the same, or similar products can be generated simultaneously in the different portions of the SF despite the different raw materials (or raw material mixtures). Depending on the characteristics of the raw materials used in the center and outer periphery of the SF, conditions of the reducing gas and/or carburizing gas injected into such zones or portions of the SF can be changed independently to achieve optimal operation. It should be appreciated that, in at least some embodiments, different reducing gases and/or carburizing gases with different conditions include gases with the same composition, temperature, and pressure, but provided in different quantities and/or provided or injected at different rates. In at least some embodiments and/or use cases, raw material that is less prone to clustering may be introduced into the peripheral flowpath in order to reduce clustering, even if the same reducing gas temperature is utilized between the central and peripheral flowpaths.

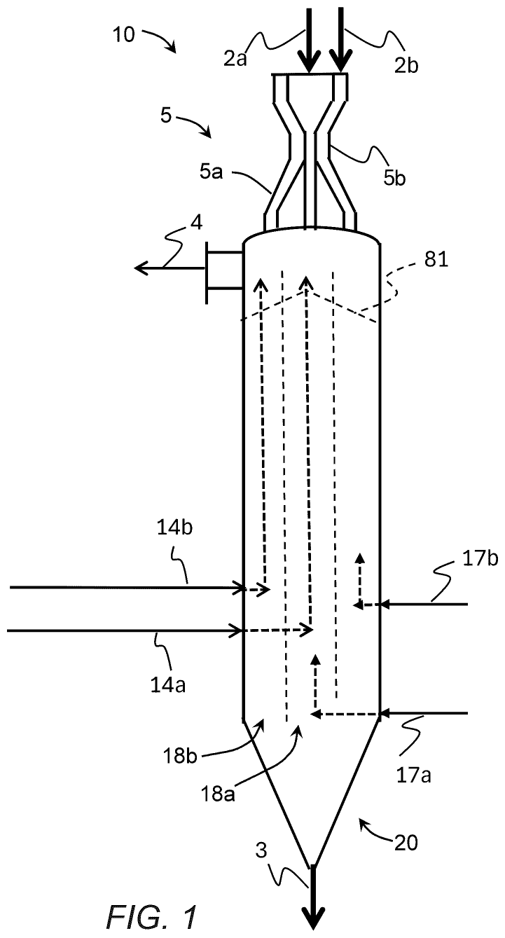

Referring now to the drawings, FIG. 1 illustrate exemplary embodiments of a SF including separate central and peripheral zones or portions for the separate reduction of different flows of iron oxide material or mixtures. Particularly, FIG. 1 illustrates a SF including distinct central and peripheral zones or portions of the SF. It will be appreciated that the exemplary direct reduced iron processes and systems depicted and described herein are by way of example only, and, in other exemplary embodiments, the DRI process, system, SF, plant, or the like may have any other suitable configuration.

As shown, the SF 10 generally receives the iron oxide 2 (e.g., a first distinct flow of iron oxide 2a and a second distinct flow of iron oxide 2b) at the top and discharges the product DRI 3 (e.g., a flow of intermixed, cooled DRI 3 shown in FIG. 1) from the bottom of the SF 10, as described in more detail below with respect to the feed system 5. The first distinct flow of iron oxide 2a and the second distinct flow of iron oxide 2b may each generally include raw material or raw material mixtures. Generally the iron oxide of flow 2a differs in chemical and/or physical properties from the iron oxide of flow 2b. The top gas 4 from the SF 1, which is the spent gas after the reduction of the iron oxide, contains the reaction product, such as H2O and CO2, as well as the unused reductant, such as H2, CO, and CH4. In some embodiments, the top gas 4 may be further utilized, such as recycling as reducing gas utilized in the SF 10.

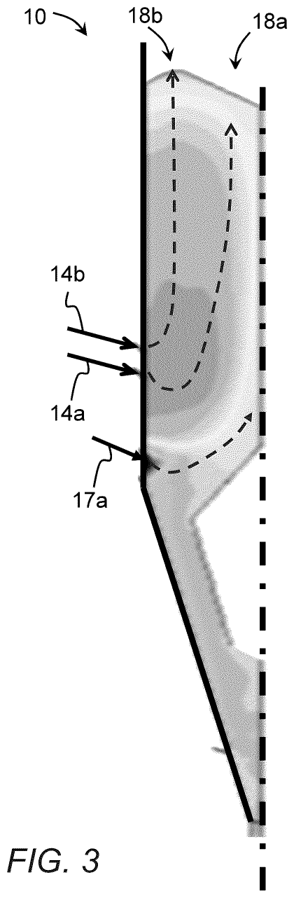

Generally, embodiments of the SF 10 define a central portion, zone, flowpath, or the like (central flowpath 18a) and a peripheral portion, zone, flowpath, or the like (peripheral flowpath 18b). The central flowpath 18a may be defined by an innermost portion of the SF 10 relative to a centerline of the SF 10. The peripheral flowpath 18b may be defined by another portion of the SF 10 circumscribing the central flowpath 18a. As generally shown in FIG. 1, the central flowpath 18a and peripheral flowpath 18b may extend from the feed system 5 at the top of the SF 10 to a transition zone and/or a cooling zone 20 located below a reduction zone of the SF 10, e.g., at a bottom of the SF 10. In some embodiments and as shown in FIG. 1, flowpaths 18a, 18b may extend from the feed system 5 to a top of the cooling zone 20 or a top of the transition zone. In other embodiments, the flowpath may extend at least partially into the cooling zone 20, such as to a bottom of the cooling zone 20. The different flowpaths 18a, 18b defined within the SF 10 may be self-defined, as described in more detail below with respect to FIG. 3, or may be partially or wholly defined by separating structures, such as walls, flow aides, flow directing baffles, and/or the like.

Referring still generally to FIG. 1, the central flowpath 18a may be configured to receive the distinct first flow of iron oxide 2a (e.g., at a stock line 81 within central flowpath 18a) and discharge a distinct first flow of reduced iron to the transition zone and/or cooling zone 20. In some such embodiments, the peripheral flowpath 18b may be configured to receive the distinct second flow of iron oxide 2b (e.g., at a stock line 81 within peripheral flowpath 18b) and discharge a distinct second flow of reduced iron to the transition zone and/or cooling zone 20. Furthermore, embodiments of the SF 10 include the feed system 5 at the top of the SF 10 configured to receive the distinct first flow of iron oxide 2a and discharge the distinct first flow of iron oxide 2a to the central flowpath 18a of the SF 10. Furthermore, the feed system 5 may be configured to receive the distinct second flow of iron oxide 2b and discharge the distinct second flow of iron oxide 2b to the peripheral flowpath 18b of the SF 10.

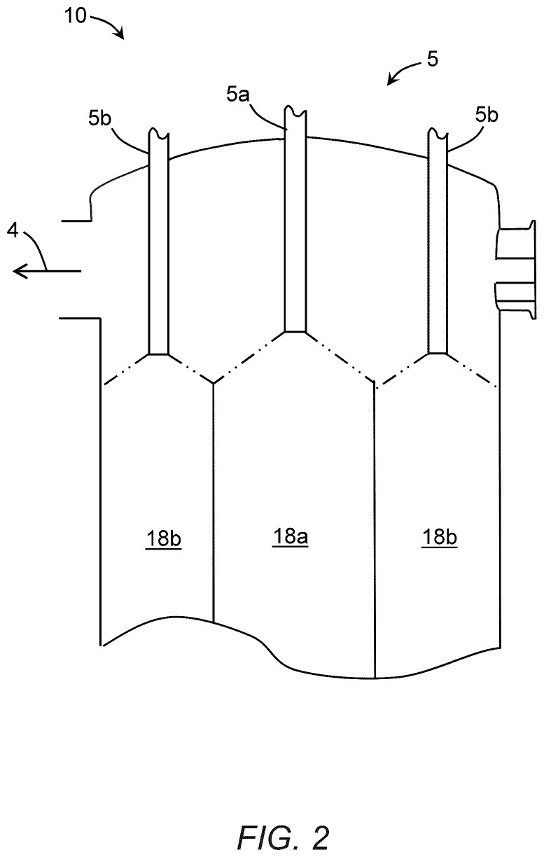

Referring now also briefly to FIG. 2, a cross-section of an exemplary embodiment of an upper portion of a SF including a feed system having multiple feed devices is illustrated schematically, in accordance with aspects of the present subject matter. In some embodiments and as shown particularly in FIGS. 1 and 2, the feed system 5 may include a first feed device 5a configured to receive the distinct first flow of iron oxide 2a and discharge, introduce, or selectively introduce the distinct first flow of iron oxide 2a to the central flowpath 18a. In some such embodiments, the feed system 5 may include a second feed device 5b configured to receive the distinct second flow of iron oxide 2b and discharge, introduce, or selectively introduce the distinct second flow of iron oxide 2b to the peripheral flowpath 18b of the SF 10. In some such embodiments or different embodiments, the second feed device 5b may be stationary. In other embodiments, the second feed device 5b may be moveable around the top portion of the SF 10 to more evenly distribute the distinct second flow of iron oxide 2b (e.g., the flowed material) about the peripheral flowpath 18b and/or an outer periphery of the SF 10.

Referring again generally to FIG. 1, the SF 10 may include a central reducing gas inlet (e.g., bustle port) configured to receive a distinct first reducing gas, bustle gas, or the like (first reducing gas 14a) and counterflow the first reducing gas 14a within the central flowpath 18a. As shown and in some embodiments, the SF 10 may also include a peripheral reducing gas inlet (e.g., bustle port) configured to receive a distinct second reducing gas, bustle gas, or the like (second reducing gas 14b) and counterflow the second reducing gas 14b within the peripheral flowpath 18b. In various embodiments and as shown, the central reducing gas inlet, bustle gas port, or a position that the first reducing gas 14a is introduced into the central flowpath 18a may be located below the peripheral reducing gas inlet, bustle gas port, or a position that the second reducing gas 14b is introduced into the peripheral flowpath 18b. In various embodiments, the central flowpath 18a may be configured to reduce the distinct first flow of iron oxide 2a only utilizing the counterflow of the first reducing gas 14a. In some such embodiments or other embodiments, the peripheral flowpath 18b may be configured to reduce the distinct second flow of iron oxide 2b only utilizing the counterflow of the second reducing gas 14b. Such separation of the flowpath 18a, 18b results from the fluid dynamics within the SF 10 and/or result from separating structures defining such flowpaths 18a, 18b within the SF. Additionally or alternatively, the second reducing gas 14b may be injected within the peripheral flowpath 18b at a higher temperature relative to the first reducing gas 14a injected within the central flowpath 18a.

As also depicted, the SF 10 may further include a central carburizing gas inlet, port, or the like configured to receive a distinct first carburizing gas 17a and inject the distinct first carburizing gas 17a into the central flowpath 18a. Furthermore or alternatively, the SF 10 may include a peripheral carburizing gas inlet, port, or the like configured to receive a distinct second carburizing gas 17b and inject the distinct second carburizing gas 17b into the peripheral flowpath 18b. The SF 10 may generally define a transition zone between the upper of the ports for reducing gas 14 (e.g., 14b in the exemplary embodiments of FIG. 1) and the lower of the ports for carburizing gas 17 (e.g., 17a in the exemplary embodiment of FIG. 1). A reduction zone of the SF 10 may generally be defined above the transition zone. The SF 10 may also generally define a cooling zone below the transition zone and/or the lower of the ports for carburizing gas 17 (e.g., 17a in the exemplary embodiment of FIG. 1). Furthermore, the flowpaths 18a and 18b may define independent reduction zones (above reducing gas 14 injection), transition zones (below reducing gas 14 injection and above carburizing gas 17 injection), and cooling zones (below carburizing gas 17 injection).

Referring now also to FIG. 3, FIG. 3 illustrates a heat map of an exemplary embodiment of a SF including multiple reducing gas injection points, in accordance with aspects of the present subject matter. As shown and in some embodiments, the SF 10 flowpaths 18a, 18b may be self-defined and/or may not be defined by the separating structure(s) of other embodiments. Generally, the fluid dynamics caused by a shape of the SF 10, the positions of the ports utilized to supply gases 14a, 14b, and/or 17a, and/or the temperatures of such gases 14a, 14b, and/or 17a may define the central flowpath 18a and/or peripheral flowpath 18b and maintain or substantially maintain the flow of the gases 14a, 14b, and/or 17a within the respective flowpaths 18 described herein. In several embodiments of the SF 10, second reducing gas 14b injected from an upper point and at a periphery of the SF 10 predominantly flows around and up through the outer periphery of the SF 10 and defines the peripheral flowpath 18b. Furthermore, first reducing gas 14a and/or first carburizing gas 17a injected from a lower point and at the center of the SF 10 predominately flows up through the center of the SF 10 and defines the central flowpath 18a, although such arrangement is not strictly necessary. It should be appreciated that an increased temperature of the peripheral gas(es) 14b and higher injection point thereof relative to the temperature of the central gas(es) 14a and 17a and lower injection point thereof may help to define a clearer and/or more discrete boundary condition between the central flowpath 18a and peripheral flowpath 18b.

Thus and in such arrangement, the raw material fed to the outer periphery of the SF 10 (e.g., the second flow of iron oxide 2b) may be reduced, substantially reduced, or predominantly reduced by second reducing gas 14b injected at the upper location, for example, while the raw material fed to the center of the SF 10 (e.g., the first flow of iron oxide 2a) may be reduced, substantially reduced, or predominantly reduced by the first reducing gas 14a injected at the lower location, for example. This is true even without internal, flow-guiding structure(s) forcing the flow of materials and gases in these distinct flowpaths 18a, 18b.

Referring again generally to FIG. 1, embodiments of the present disclosure selectively introduce, inject, or the like the first reducing gas 14a and/or first carburizing gas 17a into the center flowpath 18a of the SF 10 while selectively introducing, injecting, or the like the second reducing gas 14b and/or a second carburizing gas 17b into the peripheral flowpath 18b of the SF 10. It should be appreciated that, in several embodiments, the reducing gases 14a, 14b and carburizing gases 17a, 17b may all be introduced or injected at the lower part of the reduction zone of the SF 10, at the transition zone of the SF 10, or even at the cooling zone of the SF 10. The first reducing gas 14a and/or first carburizing gas 17a reacts with the counter-flowing first flow of iron oxide 2a in the center of the SF 10 (e.g., within center flowpath 18a). Simultaneously (or in sequence) the second reducing gas 14b and/or second carburizing gas 17b may react with the counter-flowing second flow of iron oxide 2b in the outer periphery of the SF 10 (e.g., within peripheral flowpath 18b).

Embodiments of the present subject allow for separately and/or simultaneously producing different products from different raw materials and/or producing the same, substantially the same, or similar products despite the different raw materials. This can be achieved via different reduction conditions produced in the central flowpath 18a and the peripheral flowpath 18b of the SF 10 equipped with the separate feed devices to the central flowpath 18a and the peripheral flowpath 18b by injecting different reducing/carburizing gases into the SF 10 through different injection points/ports in the vertical direction.

By changing the reducing gas condition in upper/lower injection locations, the reducing conditions in central flowpath 18a and peripheral flowpath 18b can be controlled separately and tailored to the associated raw material (or raw material mixture) of the flows of iron oxide 2a, 2b processed in the respective flowpaths 18a, 18b. Depending on the characteristics of the raw materials included in the flows of iron oxide 2a, 2b, the conditions of the first reducing gas 14a, second reducing gas 14b, first carburizing gas 17a, and/or second carburizing gas 17b can thus be changed to achieve optimal operation. For example, an amount of each of the first reducing gas 14a, the second reducing gas 14b, or a ratio therebetween may be controlled, altered, or the like at least partially based on a ratio of the received distinct first flow of iron oxide 2a and the received distinct second flow of iron oxide 2b.

Furthermore and for example, raw materials that tend to disintegrate when rapidly reduced at high temperatures may be fed to the central flowpath 18a as part of the first flow of iron oxide 2a, while raw materials that do not disintegrate or disintegrate as easily may be fed to the peripheral flowpath 18b as a part of the second flow of iron oxide 2b. In the reduction process in general, if the temperature of the reducing gas is too high, then the raw material and/or iron oxide introduced into the SF tends to sinter and form clusters. Such clustering can lead to discharge failures and uneven gas flow in SF.

Preventing clustering or excessive clustering is generally critical for stable operation of the SF. The reducing gas tends to have the highest temperature near its injection point, and the first contact may occur at the peripheral flowpath 18b, for at least some embodiments. By introducing the raw material and/or iron oxide that is less prone to clustering into the peripheral flowpath 18b, clustering inside the SF 10 can be minimized even with the same reducing gas temperature. It should be appreciated that such clustering characteristics of the different raw materials and/or iron oxides may be indicated by different classifications according to the Clustering Index as specified in ISO 11256:2015. For instance, the raw material, the second distinct flow of the iron oxide 2b, and/or the iron oxide thereof provided to the peripheral flowpath 18b may define a smaller Clustering Index (i.e., less prone to clustering) compared to the raw material, the first distinct flow of iron oxide 2a, and/or the iron oxide thereof provided to the central flowpath 18a.

Additionally or alternatively, a higher-temperature reducing gas (e.g., second reducing gas 14b) may be injected into the SF 10 from the upper of the two gas injection ports and into the peripheral flowpath 18b, and a low-temperature reducing gas (e.g., first reducing gas 14a) may be injected from the lower injection port and into the central flowpath 18a. Furthermore or alternatively, by injecting carburizing gas 17a, an endothermic carburizing reaction can be utilized to form a low-temperature reduction zone in the central flowpath 18a.

Furthermore and in some embodiments, the raw material, the first distinct flow of iron oxide 2a, and/or the iron oxide thereof provided to the central flowpath 18a and the raw material, the second distinct flow of the iron oxide 2b, and/or the iron oxide thereof provided to the peripheral flowpath 18b may be adjusted or preadjusted to have the same, similar, and/or equivalent ventilation resistances. When the ventilation resistances of the two raw materials and/or flows of iron oxide 2a, 2b fed into the center and the periphery of the SF differs significantly, the respective gas flow region may not be effectively managed even if the ratio of the reducing gas amounts is controlled. Thus, embodiments of the present subject matter allow for uniform ventilations resistance within the SF 10 bed (e.g., between the central and peripheral flowpaths 18a, 18b) even when characteristics of the raw materials and/or iron oxide differ (e.g., different reduction properties, carburization properties, clustering tendencies, sizes, or the like).

Ventilation resistance may depend on the size of the gaps through which gas flows. Furthermore, a significant difference in ventilation resistance may occur when the sizes of the two raw materials differ greatly. In some embodiments, a material may be premixed within one of the distinct first flow of iron oxide 2a or the distinct second flow of iron oxide 2b prior directing to the respective central flowpath 18a or the peripheral flowpath 18b in order to reduce or eliminate a difference in ventilation resistances of the distinct first flow of iron oxide 2a and the distinct second flow of iron oxide 2b. Thus, a same, similar, or equivalent ventilation resistance(s) may be defined by the distinct first flow of iron oxide 2a and the distinct second flow of iron oxide 2b. For example, if raw material 2a is significantly larger than raw material 2b, the packed bed will have more gaps around raw material 2a, and the ventilation resistance will decrease substantially. As a result, the amount of gas flowing through the central flowpath 18a becomes much greater than that in the peripheral flowpath 18b, making gas flow control difficult. In this exemplary setup, a finer raw material may be premixed within the distinct first flow of iron oxide 2a prior to feeding to the feed device(s) 5, 5a, and/or 5b of the SF 10 so that the ventilation resistances between the flows of iron oxide 2a, 2b becomes equivalent, similar, or the same.

The reducing gas volume ratio between the reducing gases 14a, 14b can be determined by the ratio of the amount of the two materials and/or compositions fed into the SF 10 in the flows of iron oxide 2a, 2b. For example, it is also possible to control the amount or composition of the reducing gas (e.g., based on any of flow rate, flowpath cross-sectional area, flux of material flow, or the like). The qualities, amount, flow rate, or the like of the first and second carburizing gases 17a, 17b may similarly be tailored to the materials, amount, and or flow rates of the respective flows of iron oxide 2a, 2b. Thus, embodiments of the disclosed SF 10, associated DR systems, and/or associated methods/ process may enable the production of DRI product(s) 3 while suppressing the disintegration of raw materials in the central flowpath 18a and first flow of iron oxide 2a that tend to disintegrate.

While omitted from FIG. 1, the SF 10 my include or be associated with a control unit, control system, controller, or the like providing operation control of the amount of raw materials, flow rate of the flows of iron oxide 2a, 2b, flow rates of any of the gases 14, 17, and/or conditions (e.g., temperature, chemical makeup, or the like) of any of the gases 14, 17 introduced in the shaft furnace. Such control unit may generally include an electronic control unit, multiple associated control units, and/or a combination of one or more processing devices and at least one memory or memory device, as is well known in the art, communicatively coupled to suitable input/output devices, components, and the like. Any of the process or method elements described herein may be implemented by such control unit utilizing one or more appropriate algorithms.

In some embodiments, the cooling zone 20 may be configured to receive and cool each of the distinct first flow of reduced iron (e.g. reduced first flow of iron oxide 2a) and the distinct second flow of reduced iron (e.g. reduced second flow of iron oxide 2b) and discharge an intermixed, cooled reduced iron 3 from the bottom of the SF 10.

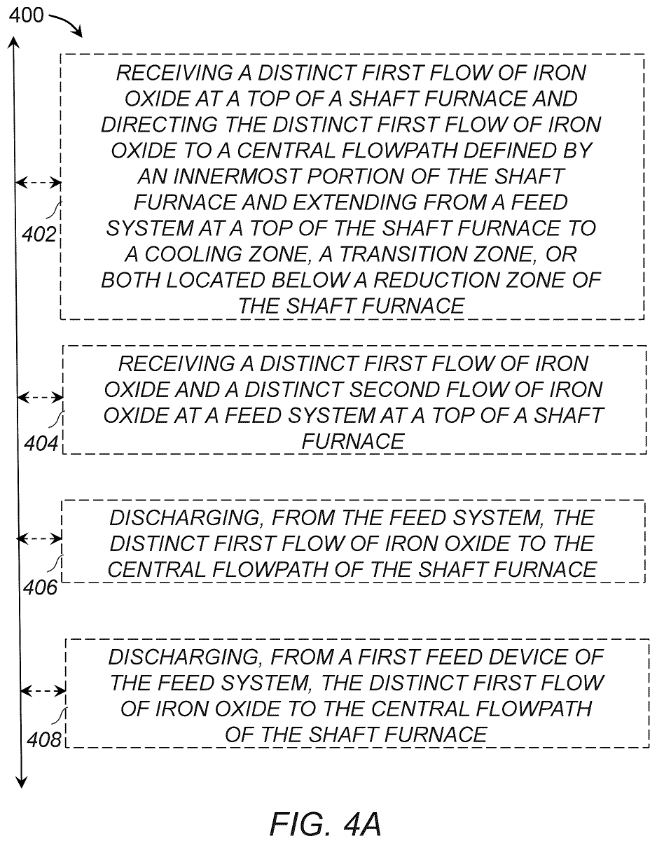

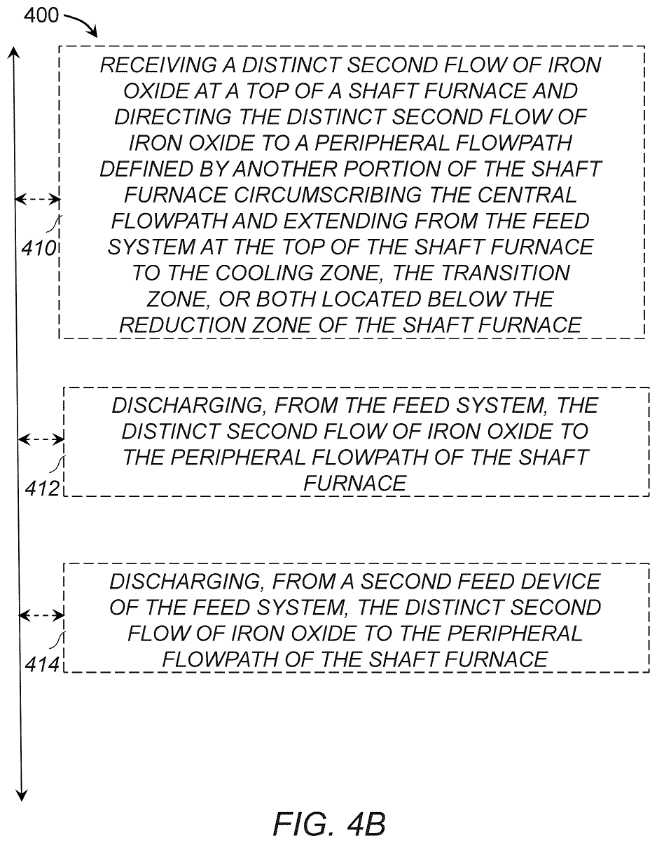

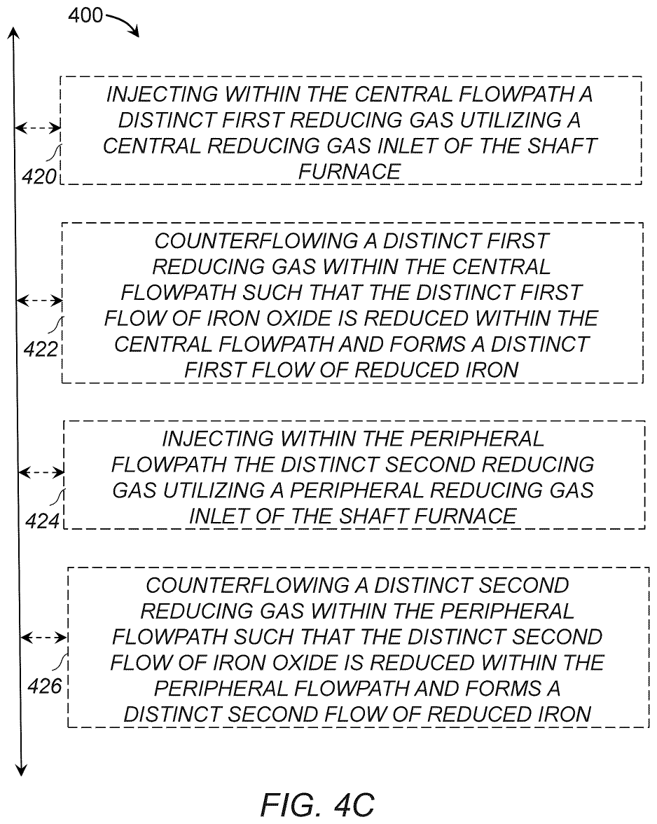

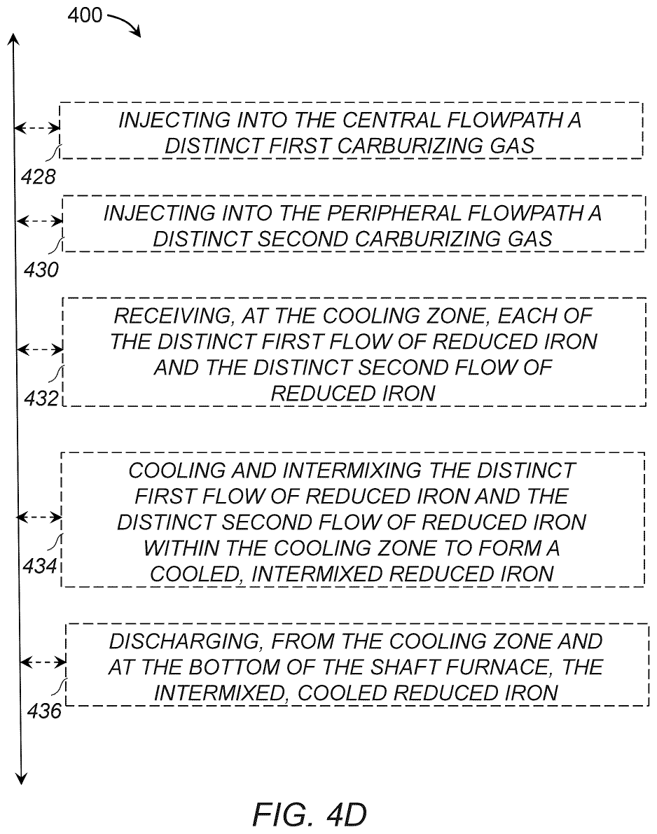

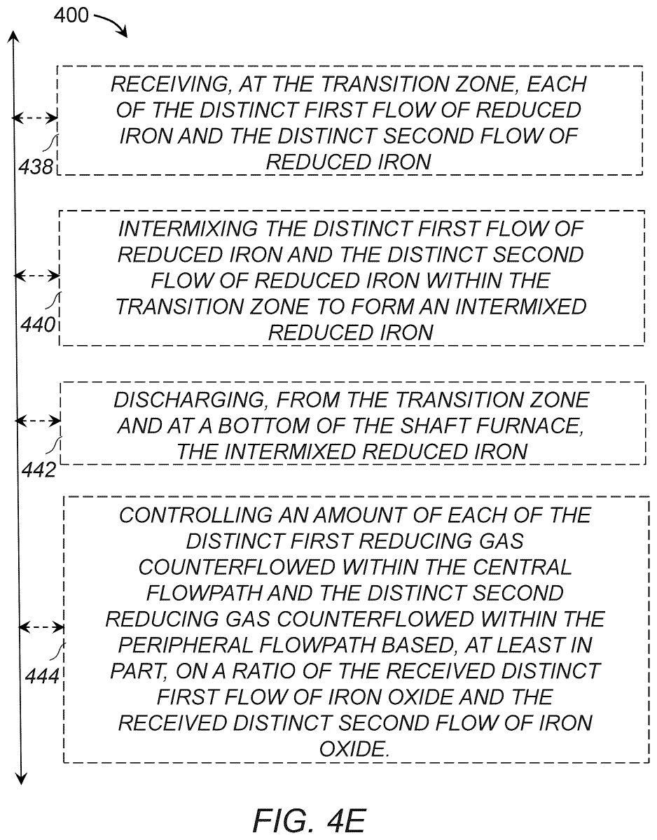

Referring now to FIGS. 4A-4E, FIGS. 4A-4E illustrate exemplary embodiments of method elements, one or more of which may be implemented in a method for the direct reduction of iron utilizing central and peripheral zones or portions of a SF, in accordance with aspects of the present subject matter. Any of such method 400 elements may, optionally, be computer-implemented, such as via a control unit as described above. Furthermore, the method 400 and/or elements thereof may be utilized to control or in association with any of the embodiments of the SF 10 or components thereof described herein or any other suitably configured DRI process, system, plant, SF, or the like.

As shown particularly in FIG. 4A, the method 400 may include receiving a distinct first flow of iron oxide at a top of a shaft furnace and directing the distinct first flow of iron oxide to a central flowpath defined by an innermost portion of the shaft furnace and extending from a feed system at a top of the shaft furnace to a cooling zone, a transition zone, or both located below a reduction zone of the shaft furnace (method element 402). Additionally or alternatively, the method 400 may include receiving a distinct first flow of iron oxide and a distinct second flow of iron oxide at a feed system at the top of the shaft furnace (method element 404). Some embodiments of the method 400 include discharging, from the feed system, the distinct first flow of iron oxide to the central flowpath of the shaft furnace (method element 406). Additionally or alternatively, the method 400 may include discharging, from a first feed device of the feed system, the distinct first flow of iron oxide to the central flowpath of the shaft furnace (method element 408).

Referring now particularly to FIG. 4B, the method 400 may additionally or alternatively include receiving a distinct second flow of iron oxide at a top of a shaft furnace and directing the distinct second flow of iron oxide to a peripheral flowpath defined by another portion of the shaft furnace circumscribing the central flowpath and extending from the feed system at the top of the shaft furnace to the cooling zone, the transition zone, or both located below the reduction zone of the shaft furnace (method element 410). In some embodiments, directing the distinct second flow of iron oxide to the peripheral flowpath may include and/or the method 400 may include discharging, from the feed system, the distinct second flow of iron oxide to the peripheral flowpath of the shaft furnace (method element 412). Additionally or alternatively, the method 400 may include discharging, from a second feed device of the feed system, the distinct second flow of iron oxide to the peripheral flowpath of the shaft furnace (method element 414). In some embodiments, the distinct second flow of iron oxide directed to the peripheral flowpath may be less prone to clustering that the iron oxide of the distinct first flow of iron oxide directed to the central flowpath, or vice-versa. In some embodiments or different embodiments, the method 400 may include premixing a material within one of the distinct first flow of iron oxide or the distinct second flow of iron oxide prior directing to the respective central flowpath or the peripheral flow path in order to reduce or eliminate a difference in ventilation resistances of the distinct first flow of iron oxide and the distinct second flow of iron oxide.

Referring now particularly to FIG. 4C, the method 400 may additionally or alternatively include injecting within the central flowpath a distinct first reducing gas utilizing a central reducing gas inlet of the shaft furnace (method element 420). Some embodiments of the method 400 may include counterflowing a distinct first reducing gas within the central flowpath such that the distinct first flow of iron oxide is reduced within the central flowpath and forms a distinct first flow of reduced iron (method element 422). Furthermore or in different embodiments, the method 400 may include injecting within the peripheral flowpath the distinct second reducing gas utilizing a peripheral reducing gas inlet of the shaft furnace (method element 424). The method 400 may additionally or alternatively include counterflowing a distinct second reducing gas within the peripheral flowpath such that the distinct second flow of iron oxide is reduced within the peripheral flowpath and forms a distinct second flow of reduced iron (method element 426). In some such embodiments, the central reducing gas inlet may be located below the peripheral reducing gas inlet.

Referring now particularly to FIG. 4D and in some additional or alternative embodiments, the distinct second reducing gas may be injected within the peripheral flowpath at a higher temperature relative to the distinct first reducing gas injected within the central flowpath. Additionally or alternatively, the method 400 may include injecting into the central flowpath a distinct first carburizing gas (method element 428). Additionally or alternatively, the method may include injecting into the peripheral flowpath a distinct second carburizing gas (method element 430). In some embodiments, the method 400 may include receiving, at the cooling zone, each of the distinct first flow of reduced iron and the distinct second flow of reduced iron (method element 432). Furthermore or alternatively, the method 400 may include cooling and intermixing the distinct first flow of reduced iron and the distinct second flow of reduced iron within the cooling zone to form a cooled, intermixed reduced iron (method element 434). The method 400 may additionally or alternatively include discharging, from the cooling zone and at the bottom of the shaft furnace, the intermixed, cooled reduced iron (method element 436).

Referring now particularly to FIG. 4E and in alternative embodiments, the method 400 may include receiving, at the transition zone, each of the distinct first flow of reduced iron and the distinct second flow of reduced iron (method element 438). Additionally or alternatively, the method 400 may include intermixing the distinct first flow of reduced iron and the distinct second flow of reduced iron within the transition zone to form an intermixed reduced iron (method element 440). In some such embodiment or other embodiments, the method 400 may include discharging, from the transition zone and at a bottom of the shaft furnace, the intermixed reduced iron (method element 442). As shown in method element 444 and in at least some additional or alternative embodiments, the method 400 may include controlling an amount of each of the distinct first reducing gas counterflowed within the central flowpath and the distinct second reducing gas counterflowed within the peripheral flowpath based, at least in part, on a ratio of the received distinct first flow of iron oxide and the received distinct second flow of iron oxide

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

Again, in various exemplary embodiments, the DRI system, SF, and associated process enable the production of DRI or the like from different raw materials (or raw material mixtures) simultaneously in the center and outer periphery of a SF. In various embodiments, the SF may be equipped with a single or multiple raw material (or raw material mixture) feed devices, which can supply separate raw materials (or raw material mixtures) to the center and the outer periphery, respectively, at the top portion of the SF. Typically, the raw material or mixtures processed in these separate center and outer periphery zones will have different characteristics or quality (e.g., reducibility). Thus, embodiments of the SF of the present disclosure generally include two or more locations for injecting reducing gas and/or carburizing gas at the lower part of the reduction zone of the SF.

By feeding different raw materials (or raw material mixtures) with different chemical and/or physical properties separately into the center and outer periphery of the SF, without mixing, and injecting different reducing gas and/or carburizing gas with different conditions into the lower part of shaft furnace, different products can be generated simultaneously in different portions of the SF. In other embodiments, the same, substantially the same, or similar products can be generated simultaneously in the different portions of the SF despite the different raw materials (or raw material mixtures). Depending on the characteristics of the raw materials used in the center and outer periphery of the SF, conditions of the reducing gas and/or carburizing gas injected into such zones or portions of the SF can be changed independently to achieve optimal operation. It should be appreciated that, in at least some embodiments, different reducing gases and/or carburizing gases with different conditions include gases with the same composition, temperature, and pressure, but provided in different quantities and/or provided or injected at different rates. In at least some embodiments and/or use cases, raw material that is less prone to clustering may be introduced into the peripheral flowpath in order to reduce clustering, even if the same reducing gas temperature is utilized between the central and peripheral flowpaths.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the scope of the present disclosure, are contemplated thereby, and are intended to be covered by the following, non-limiting Claims for all purposes.

What is claimed is:

1. A shaft furnace for the direct reduction of iron, the shaft furnace comprising:
a central flowpath defined by an innermost portion of the shaft furnace and extending from a feed system at a top of the shaft furnace to at least one of a cooling zone or a transition zone located below a reduction zone of the shaft furnace, the central flowpath configured to receive a distinct first flow of iron oxide and discharge a distinct first flow of reduced iron to at least one of the cooling zone or transition zone;
a central reducing gas inlet configured to receive a distinct first reducing gas and counterflow the distinct first reducing gas within the central flowpath;
a peripheral flowpath defined by another portion of the shaft furnace circumscribing the central flowpath and extending from the feed system at the top of the shaft furnace to at least one of the cooling zone or the transition zone located below the reduction zone of the shaft furnace, the peripheral flowpath configured to receive a distinct second flow of iron oxide and discharge a distinct second flow of reduced iron to at least one of the cooling zone or transition zone; and
a peripheral reducing gas inlet configured to receive a distinct second reducing gas and counterflow the distinct second reducing gas within the peripheral flowpath.

2. The shaft furnace of claim 1, further comprising:
the feed system at the top of the shaft furnace and configured to receive the distinct first flow of iron oxide and discharge the distinct first flow of iron oxide to the central flowpath of the shaft furnace and receive the distinct second flow of iron oxide and discharge the distinct second flow of iron oxide to the peripheral flowpath of the shaft furnace.

3. The shaft furnace of claim 1, wherein the central flowpath is configured to reduce the distinct first flow of iron oxide only utilizing the counterflow of the distinct first reducing gas, and
wherein the peripheral flowpath is configured to reduce the distinct second flow of iron oxide only utilizing the counterflow of the distinct second reducing gas.

4. The shaft furnace of claim 1, further comprising:
the cooling zone positioned below the central flowpath and the peripheral flowpath, the cooling zone configured to receive and cool each of the distinct first flow of reduced iron and the distinct second flow of reduced iron and discharge an intermixed, cooled reduced iron from the bottom of the shaft furnace.

5. The shaft furnace of claim 1, further comprising:
the transition zone positioned below the central flowpath and the peripheral flowpath, the transition zone configured to receive each of the distinct first flow of reduced iron and the distinct second flow of reduced iron and discharge an intermixed reduced iron from the bottom of the shaft furnace.

6. The shaft furnace of claim 1, further comprising:
a central carburizing gas inlet configured to receive a distinct first carburizing gas and inject the distinct first carburizing gas into the central flowpath.

7. The shaft furnace of claim 1, further comprising:
a peripheral carburizing gas inlet configured to receive a distinct second carburizing gas and inject the distinct second carburizing gas into the peripheral flowpath.

8. The shaft furnace of claim 1, further comprising:
at least one separating structure housed within the shaft furnace and at least partially defining and separating the central flowpath and the peripheral flowpath.

9. The shaft furnace of claim 1, wherein the central reducing gas inlet is located below the peripheral reducing gas inlet.

10. A method for the direct reduction of iron, the method comprising:
receiving a distinct first flow of iron oxide at a top of a shaft furnace and directing the distinct first flow of iron oxide to a central flowpath defined by an innermost portion of the shaft furnace and extending from a feed system at a top of the shaft furnace to at least one of a cooling zone or a transition zone located at below a reduction zone of the shaft furnace;
receiving a distinct second flow of iron oxide at a top of a shaft furnace and directing the distinct second flow of iron oxide to a peripheral flowpath defined by another portion of the shaft furnace circumscribing the central flowpath and extending from the feed system at the top of the shaft furnace to at least one of the cooling zone or the transition zone located below the reduction zone of the shaft furnace;
counterflowing a distinct first reducing gas within the central flowpath such that the distinct first flow of iron oxide is reduced within the central flowpath and forms a distinct first flow of reduced iron; and
counterflowing a distinct second reducing gas within the peripheral flowpath such that the distinct second flow of iron oxide is reduced within the peripheral flowpath and forms a distinct second flow of reduced iron.

11. The method of claim 10, wherein the iron oxide of the distinct second flow of iron oxide directed to the peripheral flowpath is less prone to clustering that the iron oxide of the distinct first flow of iron oxide directed to the central flowpath.

12. The method of claim 10, wherein receiving the distinct first flow of iron oxide at the top of the shaft furnace, directing the distinct first flow of iron oxide to the central flowpath, receiving the distinct second flow of iron oxide at the top of the shaft furnace, and directing the distinct second flow of iron oxide to the peripheral flowpath comprises:
receiving the distinct first flow of iron oxide and the distinct second flow of iron oxide at a feed system at the top of the shaft furnace;
discharging, from the feed system, the distinct first flow of iron oxide to the central flowpath of the shaft furnace; and
discharging, from the feed system, the distinct second flow of iron oxide to the peripheral flowpath of the shaft furnace.

13. The method of claim 10, further comprising:
receiving, at the cooling zone, each of the distinct first flow of reduced iron and the distinct second flow of reduced iron;
cooling and intermixing the distinct first flow of reduced iron and the distinct second flow of reduced iron within the cooling zone to form a cooled, intermixed reduced iron; and
discharging, from the cooling zone and at a bottom of the shaft furnace, the intermixed, cooled reduced iron.

14. The method of claim 10, further comprising:
receiving, at the transition zone, each of the distinct first flow of reduced iron and the distinct second flow of reduced iron;
intermixing the distinct first flow of reduced iron and the distinct second flow of reduced iron within the transition zone to form an intermixed reduced iron; and
discharging, from the transition zone and at a bottom of the shaft furnace, the intermixed reduced iron.

15. The method of claim 10, further comprising:
injecting into the central flowpath a distinct first carburizing gas.

16. The method of claim 10, further comprising:
premixing a material within one of the distinct first flow of iron oxide or the distinct second flow of iron oxide prior directing to the respective central flowpath or the peripheral flow path in order to reduce or eliminate a difference in ventilation resistances of the distinct first flow of iron oxide and the distinct second flow of iron oxide.

17. The method of claim 10, wherein the shaft furnace includes at least one separating structure housed within the shaft furnace and at least partially defining and separating the central flowpath and the peripheral flowpath.

18. The method of claim 10, further comprising:
injecting within the central flowpath the distinct first reducing gas utilizing a central reducing gas inlet of the shaft furnace; and
injecting within the peripheral flowpath the distinct second reducing gas utilizing a peripheral reducing gas inlet of the shaft furnace,
wherein the central reducing gas inlet is located below the peripheral reducing gas inlet.

19. The method of claim 10, wherein the distinct second reducing gas is injected within the peripheral flowpath at a higher temperature relative to the distinct first reducing gas injected within the central flowpath.

20. The method of claim 10, further comprising:
controlling an amount of each of the distinct first reducing gas counterflowed within the central flowpath and the distinct second reducing gas counterflowed within the peripheral flowpath based, at least in part, on a ratio of the received distinct first flow of iron oxide and the received distinct second flow of iron oxide.
